(19) United States
(12) Patent Application Publication
(10) Pub. No.: US 2025/0024287 A1
(43) Pub. Date: Jan. 16, 2025

(54) METHOD FOR QOE MEASUREMENT

(71) Applicant: ZTE CORPORATION, Shenzhen (CN)

(72) Inventors: Jie TAN, Shenzhen (CN); Yuan GAO, Shenzhen (CN); Zhenghong QIU, Shenzhen (CN); Xiubin SHA, Shenzhen (CN)

(73) Assignee: ZTE CORPORATION, Shenzhen (CN)

(21) Appl. No.: 18/899,435

(22) Filed: Sep. 27, 2024

Related U.S. Application Data
(63) Continuation of application No. PCT/CN2022/111566, filed on Aug. 10, 2022.

(51) Int. Cl. H04W 24/08; H04W 76/27

(52) U.S. Cl. CPC H04W 24/08; H04W 76/27

(57) ABSTRACT

The present disclosure relates to a wireless communication method for use in a wireless terminal, the method comprising: receiving, from a wireless network node, a quality of experience, QoE, measurement configuration for a non-connected state, wherein the non-connected state comprises an idle state and/or an inactive state. The present disclosure further relates to a wireless communication method for use in a wireless network node, the method comprising: transmitting, to a wireless terminal, a quality of experience, QoE, measurement configuration for a non-connected state, wherein the non-connected state comprises an idle state and/or an inactive state.

### CROSS-REFERENCE TO RELATED APPLICATION

This application claims the benefit of priority under 35 U.S.C. § 120 as a continuation of International Patent Application No. PCT/CN2022/111566, filed on Aug. 10, 2022, the disclosure of which is incorporated herein by reference in its entirety.

### TECHNICAL FIELD

This document is directed generally to wireless communications, in particular to 5th generation 5G wireless communications, e.g. 5G New Radio (5G NR), and more particularly to QoE measurement.

### BACKGROUND

Understanding end to end customers' experience, e.g. throughput, data loss, latency, has attracted the attention of network operators. The Quality of Experience (QoE) measurement can be defined based on different applications and measurements taking place at the UE's application layer, including the measurement of throughput, data loss, latency etc.

### SUMMARY

An NR (New Radio) QMC (QoE measurement collection) function is activated by OAM (operations, administration and maintenance) via a separate QMC framework. For signalling-based QoE, the QMC configuration for a specific UE is sent from OAM to CN (Core Network), and then the CN sends the QMC configuration to a Radio Access Node (RAN) node via UE-associated signalling. For management-based QoE, the OAM sends the QMC configuration to a RAN node, and the RAN selects UEs which satisfies the condition for QoE measurement and sends the configuration to the UEs.

RAN visible QoE is a sub-feature of QoE. The RAN can configure the RAN visible QoE based on its own requirement, when the QoE has been activated. The RAN visible QoE should be associated with QoE by the measurement id of QoE. The UE collects the RAN visible QoE measurement results and reports them to RAN node. The RAN node would use the measurement results for network optimisation. In a central unit-distributed unit (CU-DU) split architecture, the CU should transfer the RAN visible QoE measurement results to the DU via F1AP. In addition, the QoE measurements need to be further enhanced.

In this disclosure, a method of QoE measurement supporting multiple service types is proposed in non-connected states, NR-DC and handover scenarios.

This document relates to methods, systems, and devices for QoE measurement.

The present disclosure relates to a wireless communication method for use in a wireless terminal, the method comprising:
receiving, from a wireless network node, a quality of experience, QoE, measurement configuration for a non-connected state.
wherein the non-connected state comprises an idle state and/or an inactive state.

Various embodiments may preferably implement the following features.

Preferably or in some embodiments, the method, in particular the QoE measurement configuration for the non-connected state, more particularly receiving the QoE measurement configuration for the non-connected state comprises:
receiving, from the wireless network node, an indication of the QoE measurement configuration for a connected state being applicable for the QoE measurement configuration for the non-connected state,
wherein the indication is in a radio resource control, RRC, reconfiguration message or an RRC resume message.

Preferably or in some embodiments, the QoE measurement configuration in the non-connected state comprises:
receiving, from the wireless network node, the QoE measurement configuration for the non-connected state when releasing QoE measurement configuration for a connected state,
wherein the QoE measurement configuration for the at least one non-connected state is in an RRC release message.

Preferably or in some embodiments, the QoE measurement configuration in the non-connected state comprises:
receiving, from the wireless network node, modification information when releasing QoE measurement configuration for a connected state,
wherein the QoE configuration for the non-connected state is determined based on the QoE measurement configuration for the connected state and the modification information in an RRC release message.

Preferably or in some embodiments, the QoE measurement configuration for the non-connected state is an application layer measurement configuration, AppLayerMeasConfig, and the QoE measurement configuration comprises at least one of:
a measurement configuration App Layer To Add Modify List,
a measurement Configuration App Layer To Release List,
an RRC segmentation Allowed,
a measurement Configuration App Layer identifier,
a measurement Configuration App Layer Container,
a service Type,
a pause Reporting,
a transmission Of Session Start Stop,
a network slice list,
short internet protocol information,
a periodicity,
a number of Buffer Level Entries, or
a Report Playout Delay For Media Start up.

Preferably or in some embodiments, the wireless terminal is in the non-connected state, and preferably the method further comprises:
transmitting, to the wireless network node, QoE measurement information based on a periodicity or at least one triggering event.

Preferably or in some embodiments, the QoE measurement information relates to a QoE report.

Preferably or in some embodiments, the wireless terminal is in the non-connected state, and preferably the method further comprises:
switching to a connected state based on at least one triggering event, and
transmitting, to the wireless network node, QoE measurement information.

Preferably or in some embodiments, the QoE measurement information is transmitted in a message 3 or a message 5 of a random access procedure for switching to the connected state.

Preferably or in some embodiments, the switching to the connected state based on at least one triggering condition comprises:
transmitting, to the wireless network node, an indication of a QoE measurement reporting being triggered, and
receiving, from the wireless network node, a request for the QoE measurement information.

Preferably or in some embodiments, the QoE, measurement configuration is associated with at least one of an augmented reality service, a mixed reality service or a multicast and broadcast service, and the QoE measurement information comprises at least one of:
a QoE measurement report,
a radio access network visible QoE, RVQoE, measurement report,
a QoE measurement reporting value,
a RVQoE measurement reporting value, or
an application layer indication indicating an effect of user experience.

Preferably or in some embodiments, the at least one triggering event comprises at least one of:
an indication from an application layer,
a QoE measurement reporting value exceeds a threshold,
a RVQoE reporting value exceeds the threshold, or
one or more indicators in the QoE measurement report respectively exceed one or more thresholds corresponding to the one or more indicators.

Preferably or in some embodiments, the method further comprises:
transmitting, to the wireless network node, capability information of supporting QoE measurements in the non-connected state, and
transmitting, to the wireless network node, capability information of supporting QoE measurements for at least one of augmented reality service, mixed reality service or multicast and broadcast service.

The present disclosure further relates to a wireless terminal comprising a processor configured to receive, from a wireless network node, a quality of experience, QoE, measurement configuration for a non-connected state, wherein the non-connected state comprises an idle state and/or an inactive state.

Preferably or in some embodiments, the processor is further configured to perform the method as outlined above.

The present disclosure further relates to a wireless communication method for use in a wireless network node, the method comprising:
transmitting, to a wireless terminal, a quality of experience, QoE, measurement configuration for a non-connected state,
wherein the non-connected state comprises an idle state and/or an inactive state.

Various embodiments may preferably implement the following features.

Preferably or in some embodiments, the QoE measurement configuration for the non-connected state comprises at least one of:
transmitting, to the wireless terminal, an indication of the QoE measurement configuration by a radio resource control, RRC, reconfiguration message or an RRC resume message, or
transmitting, to the wireless terminal, the QoE measurement configuration by RRC release message, or
transmitting, to the wireless terminal, modification information by RRC release message

Preferably or in some embodiments, the wireless terminal is in the non-connected state, and preferably the method further comprises at least one of:
receiving, from the wireless terminal, QoE measurement information based on a periodicity or at least one triggering event, or
receiving, from the wireless terminal, an indication of a QoE measurement reporting being triggered.

Preferably or in some embodiments, QoE measurement information relates to a QoE report.

Preferably or in some embodiments, the QoE measurement configuration is associated with at least one of an augmented reality service, a mixed reality service or a multicast and broadcast service, and the QoE measurement information comprises at least one of:
a QoE measurement report,
a radio access network visible QoE, RVQOE, measurement report,
a QoE measurement reporting value,
a RVQoE measurement reporting value, or
an application layer indication indicating an effect of user experience.

Preferably or in some embodiments, the at least one triggering event comprises at least one of:
an indication from an application layer,
a QoE measurement reporting value exceeds a threshold,
a RVQoE reporting value exceeds the threshold, or
one or more indicators in the QoE measurement report respectively exceed one or more thresholds corresponding to the one or more indicators.

Preferably or in some embodiments, the method further comprises:
receiving, from the wireless terminal, capability information of supporting QoE measurements in the non-connected state, and
receiving, from the wireless terminal, capability information of supporting QoE measurements for at least one of augmented reality service, mixed reality service or multicast and broadcast service.

The present disclosure further relates to a wireless network node comprising a processor configured to: transmit, to a wireless terminal, a quality of experience, QoE, measurement configuration for a non-connected state, wherein the non-connected state comprises an idle state and/or an inactive state.

Preferably or in some embodiments, the processor is further configured to perform the method as outlined above.

The present disclosure further relates to a wireless communication method for use in a wireless terminal, the method comprising:
receiving, from a first wireless network node or a second wireless network node, a quality of experience, QoE, measurement configuration for a dual-connectivity mode,
wherein the first wireless network node is one of a master node and a secondary node and the second wireless network node is another one of the master node and the secondary node.

Various embodiments may preferably implement the following features.

Preferably or in some embodiments, the method further comprises:
transmitting QoE measurement information associated with the dual-connectivity mode to the first wireless network node based on the QoE measurement configuration for the dual-connectivity mode.

Preferably or in some embodiments, the method further comprises:
transmitting, to the second wireless network node, the QoE measurement information based on the QoE measurement configuration for the dual-connectivity mode.

Preferably or in some embodiments, the method further comprises:
receiving, from the first wireless network node or the second wireless network node, an indication associated with reporting the QoE measurement information, and
transmitting, to the second wireless network node or the first wireless network node, the QoE measurement information,
wherein the indication is in downlink control information, a radio resource control message or a media access control control element.

Preferably or in some embodiments, the QoE measurement information is transmitted to the master node via a signaling radio bearer 4, and the QoE measurement information is transmitted to the secondary node via at least one of a signaling radio bearer 3, a split signaling radio bearer 4 or a signaling radio bearer configured for reporting the QoE measurement information associated with the dual-connected mode.

Preferably or in some embodiments, the method further comprises:
transmitting, to the first or secondary wireless network node, assistance information associated aligning measurement results in the QoE measurement information,
wherein the assistance information comprises at least one of:
an absolute timestamp,
a relative timestamp,
network slice information,
a QoE measurement identifier, or
a radio access network visible QoE measurement identifier.

Preferably or in some embodiments, the QoE measurement configuration is associated with at least one of an augmented reality service, a mixed reality service or a multicast and broadcast service, and wherein the wireless communication method further comprises:
transmitting, to the first wireless network node or the second wireless network node, capability information of supporting QoE measurements for at least one of the augmented reality service, the mixed reality service or the multicast and broadcast service.

The present disclosure further relates to a wireless terminal comprising a processor configured to: receive, from a first wireless network node or a second wireless network node, a quality of experience, QoE, measurement configuration for a dual-connectivity mode, wherein the first wireless network node is one of a master node and a secondary node and the second wireless network node is another one of the master node and the secondary node.

Preferably or in some embodiments, the processor is further configured to perform the method as outlined above.

The present disclosure further relates to a wireless communication method for use in a first wireless network node, the method comprising:
receiving, from a wireless terminal, quality of experience, QoE, measurement information associated with a dual-connectivity mode,
wherein the first wireless network node is one of a master node and a secondary node connected to the wireless terminal.

Various embodiments may preferably implement the following features.

Preferably or in some embodiments, the method further comprises:
receiving, from the wireless terminal, the QoE measurement information based on the QoE measurement configuration for the dual-connectivity mode.

Preferably or in some embodiments, the method further comprises:
transmitting an indication associated with reporting the QoE measurement information, and
receiving, from the wireless terminal, the QoE measurement information,
wherein the indication is in downlink control information, a radio resource control message or a media access control control element.

Preferably or in some embodiments, the QoE measurement information is received via a signaling radio bearer 4, and the QoE measurement information is received via at least one of a signaling radio bearer 3, a split signaling radio bearer 4 or a signaling radio bearer configured for reporting the QoE measurement information associated with the dual-connected mode.

Preferably or in some embodiments, the method further comprises:
receiving, from the wireless terminal, assistance information associated aligning measurement results in the QoE measurement information,
wherein the assistance information comprises at least one of:
an absolute timestamp,
a relative timestamp,
network slice information,
a QoE measurement identifier, or
a radio access network visible QoE measurement identifier.

The present disclosure further relates to a first wireless network node comprising a processor configured to: receive, from a wireless terminal, quality of experience, QoE, measurement information associated with a dual-connectivity mode, wherein the first wireless network node is one of a master node and a secondary node connected to the wireless terminal.

Preferably or in some embodiments, the processor is further configured to perform the method as outlined above.

The present disclosure further relates to a wireless communication method for use in a source wireless network node, the method comprising:
transmitting, to an access and mobility management function, a handover required message comprising a first quality of experience, QoE, configuration of the source wireless network node,
receiving, from the access and mobility management function, a signaling comprising a second QoE configuration of a target wireless network node, wherein the first QoE configuration is different from the second QoE configuration,
receiving, from the access and mobility management function, a handover command of handing over the wireless terminal to the target wireless network node, and
transmitting, to the wireless network node, the handover command or a dedicated signaling comprising the second QoE configuration.

Various embodiments may preferably implement the following features.

Preferably or in some embodiments, the source wireless network node is one of a gNB or a next generation eNodeB, ng-eNB, and the target wireless network node is another one of the gNB and the ng-eNB.

Preferably or in some embodiments, the first QoE configuration comprises at least one of:
a service type,
a measurement configuration for application layer of the source wireless network node,
a QoE metric,
reporting server information,
a reporting interval,
a QoE measurement collection identifier for a session, or
QoE area scope information.

Preferably or in some embodiments, the second QoE configuration comprises at least one of:
a measurement configuration for application layer of the target wireless network node,
an indication of whether to support QoE measurements of an existing service,
an indication of a measurement configuration application layer identifier for performing the QoE measurements of the existing service, or
an indication associated with instructing the wireless terminal to report according to a format of the target wireless network node after the handover is completed, or
a QoE measurement collection identifier for a session.

The present disclosure further relates to a source wireless network node comprising a processor configured to: transmit, to an access and mobility management function, a handover required message comprising a first quality of experience, QoE, configuration of the source wireless network node, receive, from the access and mobility management function, a signaling comprising a second QoE configuration of a target wireless network node, wherein the first QoE configuration is different from the second QoE configuration, receive, from the access and mobility management function, a handover command of handing over the wireless terminal to the target wireless network node, and transmit, to the wireless network node, the handover command or a dedicated signaling comprising the second QoE configuration.

Preferably or in some embodiments, the processor is further configured to perform any method as outlined above.

The present disclosure relates to a computer program product comprising a computer-readable program medium code stored thereupon, the code, when executed by a processor, causing the processor to implement a wireless communication method recited in any one of the foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of the transmission/reception of QoE UE capability parameters for AR, MR, MBS and other service types according to an embodiment.

FIG. 2 shows a schematic diagram of the transmission/reception of QoE UE capability parameters in non-connected states according to an embodiment.

FIG. 3 shows a schematic diagram of QoE measurement configuration and report in non-connected states according to an embodiment.

FIGS. 4A to 4E show schematic diagrams of QoE measurement reporting according to an embodiment.

FIG. 5 shows a schematic diagram of alignment of QoE measurements according to an embodiment.

FIGS. 6A and 6B show schematic diagrams of legacy QoE measurements according to an embodiment.

FIG. 7 shows a schematic diagram of a wireless terminal according to an embodiment.

FIG. 8 shows a schematic diagram of a wireless network node according to an embodiment.

FIGS. 9 to 13 show flowcharts of methods according to some embodiments of the present disclosure.

### DETAILED DESCRIPTION

### Embodiment 1 (QoE UE Capability Parameters for AR, MR, MBS and Other Service Types)

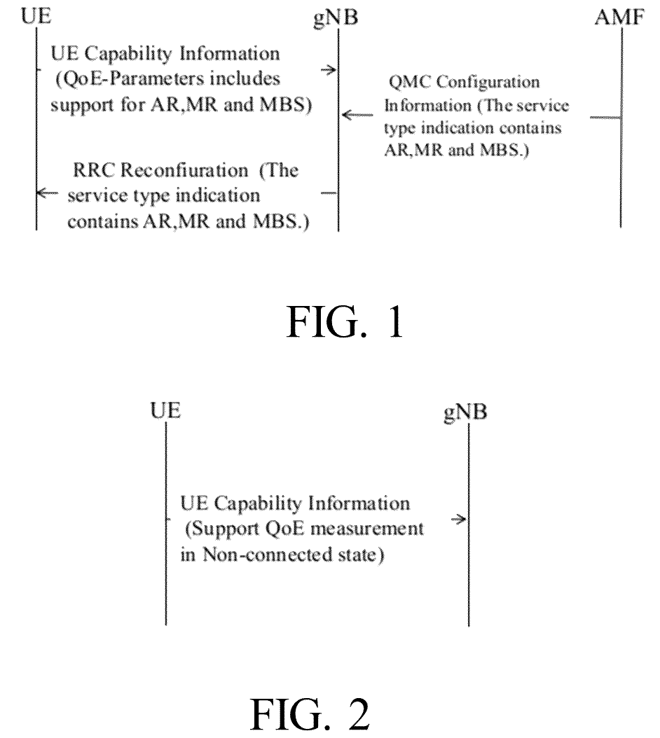

FIG. 1 shows a schematic diagram of the transmission/reception of QoE UE capability parameters for AR (augmented reality), MR (mixed reality), MBS (multicast and broadcast service) and other service types according to an embodiment.

Considering some new supported service types in the QoE measurement, it is necessary to carry the new service types when the core network and gNB are indicated to perform the QoE measurement. E.g., the QMC Configuration Information of the core network and the RRC Reconfiguration of gNB contain the service types of AR, MR and MBS. In addition, similar to streaming and MTSI service (multimedia telephony service) which already supports QoE measurement, the new service types that need to be supported are reported in the capability information of UE. That is, the QoE-Parameters of UE Capability Information includes QoE measurement of whether AR, MR and MBS are supported.

### Embodiment 2 (QoE UE Capability Parameters in Non-Connected States)

FIG. 2 shows a schematic diagram of the transmission/reception of QoE UE capability parameters in non-connected states according to an embodiment.

Considering that QoE supports MBS measurement under RRC_INACTIVE and RRC_IDLE states, this means that it is necessary to know whether the current UE supports non-connected-state QoE measurement before the core network and that the gNB distributes the QoE measurement configuration. The UE Capability Information contains the indication of whether QoE measurement is supported. The indication includes at least one of the following: only RRC_INACTIVE measurements are supported, only RRC_IDLE measurements are supported, non-connected measurements are supported, RRC_INACTIVE and RRC_IDLE measurements are supported.

### Embodiment 3 (QoE Measurement Configuration and Report in Non-Connected States)

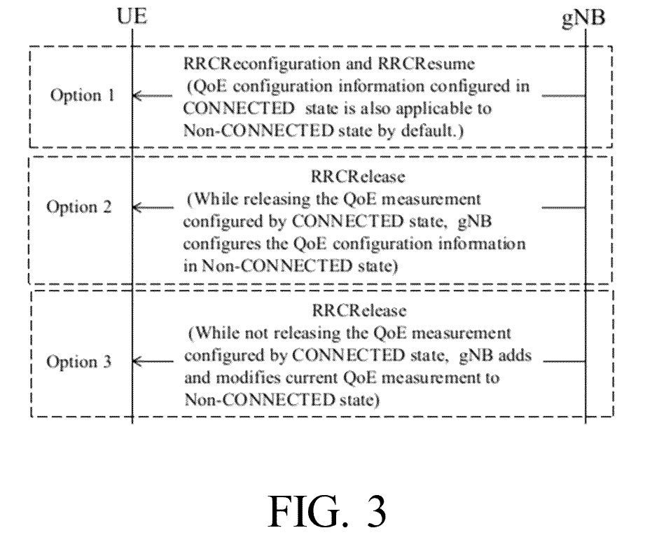

FIG. 3 shows a schematic diagram of QoE measurement configuration and report in non-connected states according to an embodiment.

### Measurement Configuration

In Rel 18, in order to support QoE measurements in Non-CONNECTED state, the gNB needs to configure the QoE measurement information used in the Non-CONNECTED state for the UE in CONNECTED state. According to the embodiment, the configuration of the above information is as follows:
Option 1: Indicates that the currently configured QoE configuration information is also applicable to Non-CONNECTED state by default or defining an indication in RRCReconfiguration and RRCResume.
Option 2: In RRCRelease, while releasing the QoE measurement information configured by CONNECTED state, the gNB configures the QoE measurement information in Non-CONNECTED state.
Option 3: In RRCRelease, while releasing the QoE measurement information configured by CONNECTED state, the gNB adds and modifies the current QoE measurement to Non-CONNECTED state.

The QoE configuration information is AppLayerMeasConfig, which includes at least one of the following items: measurement Configuration App Layer To Add Modify List, measurement Configuration App Layer To Release List, RRC segmentation Allowed, measurement Configuration App Layer Id, measurement Configuration App Layer Container, service Type, pause Reporting, transmission Of Session Start Stop, slice list, Short IP information, Periodicity, Number Of Buffer Level Entries, Report Playout Delay For Media Start up.

These parameters are further specified in the appendix.

### Measurement Reporting

In non-connected states, the processing of QoE measurement reporting for a service (e.g, MBS) includes at least one of the following methods:
Option 1: when the UE enters connected, the UE reports the QoE measurement reporting stored in UE.
Option 2: in the non-connected state, the UE reports the QoE measurement information based on periodicity or event triggers.
Option 3: in the non-connected state, the UE triggers a state switch to be connected based on the QoE measurement information.

In Option2, in the non-connected state, the UE sends QoE measurement information to the gNB through small data transmission (SDT). The QoE measurement information contains at least one of the following: legacy QoE measurement reporting, RVQoE measurement reporting, QoE measurement reporting level value, RVQoE value, a UE application layer indication indicating the effect of user experience, slice information, QoE measurement ID, and RAN visible QoE measurement ID.

The above information shall be sent in at least one of the following methods:
Periodic reporting, which is provided by the gNB when configuring non-connected state QoE measurements, or which is implemented by UE.
Event trigger, wherein the trigger condition includes at least one of the following: the indication information of the UE application layer, the QoE measurement reporting level exceeds a threshold, RVQoE value exceeds a threshold, and/or one or more indicators in the QoE measurement reporting exceed the corresponding threshold.

The above threshold is carried by the core network or gNB when configuring QoE measurement parameters.

The carrying method includes one of the following: the threshold value is included in the QoE configuration container, and/or the threshold value is included in RRC signaling.

In Option3, in the non-connected state, the UE triggers to switch to connected state based on the QoE measurement information. The QoE measurement information includes at least one of the following: legacy QoE measurement reporting, RVQoE measurement reporting, QoE measurement reporting level value, RVQoE value, a UE application layer indication indicating the effect of user experience.

The condition for triggering UE to enter the connected state includes at least one of the following: the indication information of the UE application layer, the QoE measurement reporting level exceeds a threshold, RVQoE value exceeds a threshold, and/or one or more indicators in the QoE measurement reporting exceed the corresponding threshold.

The above threshold is carried by the core network or gNB when configuring QoE measurement parameters.

The carrying method includes at least one of the following: the threshold value is included in the QoE configuration container, and/or the threshold value is included in RRC signaling.

During state switching, MSG3 or MSG5 in PRACH contains at least one of the following:
the QoE measurement reporting, an indication information indicating that there is a QoE measurement reporting triggering the state transition on the UE side.

Further, after entering the connected state, the gNB requests the UE to report the QoE measurement reporting based on the above indication information.

### Embodiment 4 (MN or SN Sends the QoE Measurement Reporting to the UE)

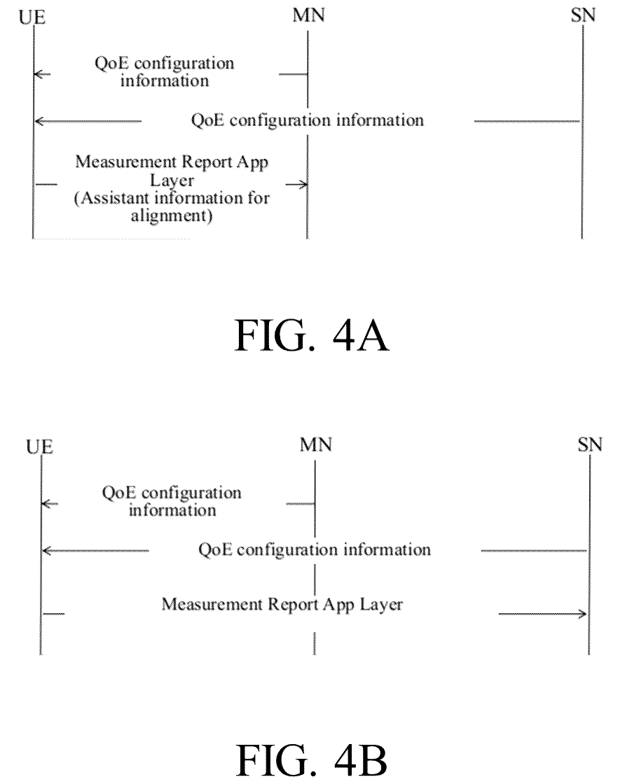

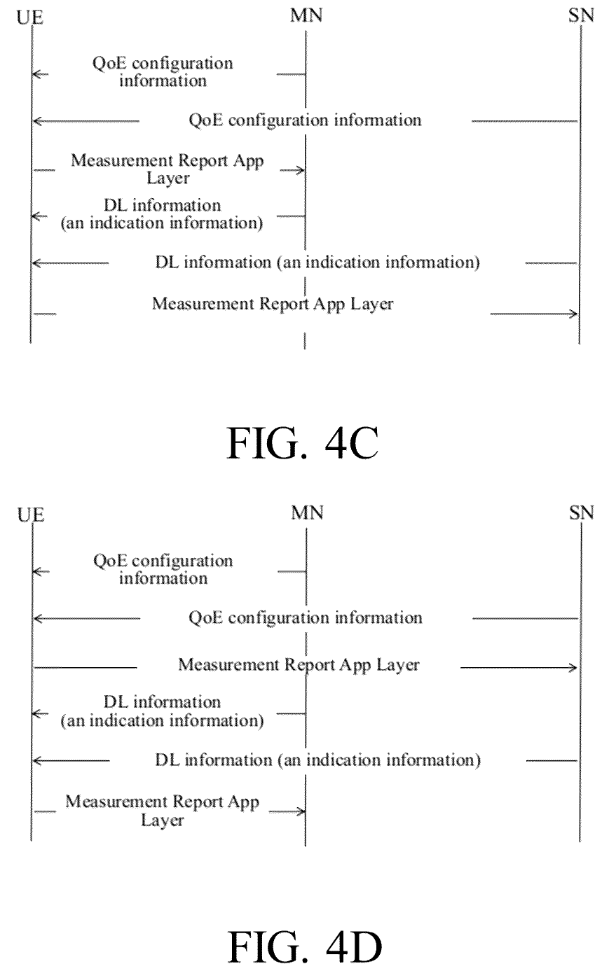

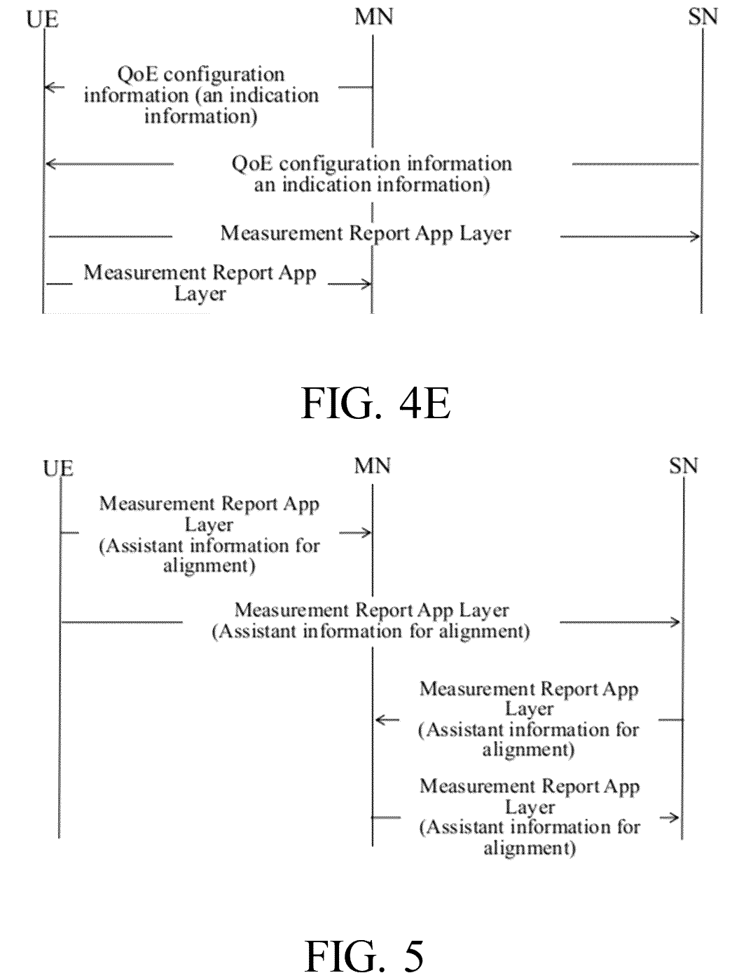

FIG. 4A shows a schematic diagram of QoE measurement reporting according to an embodiment.

In the current standard, MCG SRB in a DC scenario supports SRB1 and SRB2 transmission, and SCG SRB supports SRB3 transmission. Among them, in the single connection scenario, due to the low priority based on QoE report, the QoE report separately introduces SRB4 with low priority to transmit the above measurement report. Therefore, it is necessary for MN to support the above measurement report transmitted by SRB4. For SN, since SRB3 supports reporting measurement reports, SRB3, split SRB4 or new SRB5 can be used to transmit QoE measurement reports. For the UE, the UE indicates whether the UE supports RRC segmentation of the measurement report message in uplink. The above measurement reports include both RAN visible QoE and legacy QoE reports. In the case of NR-DC, the UE measurement reporting method includes at least one of the following:
MN or SN configures QoE measurement information, and UE always sends measurement reporting to MN, as shown in FIG. 4A. The QoE measurement reporting is reported to MN through SRB4.

FIG. 4B shows a schematic diagram of QoE measurement reporting according to an embodiment.

The MN or the SN configures the QoE measurement information, and the UE always sends measurement reporting to the SN, as shown in FIG. 4B. The QoE measurement reporting is reported to SN through SRB3, split SRB4 or new SRB5.

FIG. 4C shows a schematic diagram of QoE measurement reporting according to an embodiment.

The MN or the SN configures QoE measurement information, and the UE sends measurement reporting to the MN by default. The MN or the SN can indicate the UE to report measurement reporting to the SN through an indication information, as shown in FIG. 4C. The QoE measurement reporting is reported to the MN through SRB4, and the QoE measurement reporting is also reported to the SN through SRB3, split SRB4 or new SRB5. The DL information includes at least one of the following: DLInformationTransfer, RRC message, MAC CE contains the indication information, and the DCI contains the indication information. The RRC message contains at least one of the following: RRCReestablishment, RRCReconfiguration, RRCResume, RRCReject, RRCSetup.

FIG. 4D shows a schematic diagram of QoE measurement reporting according to an embodiment.

The MN or the SN configures QoE measurement information, and the UE sends measurement reporting to the SN by default. The MN or the SN can indicate the UE to report measurement reporting to the MN through an indication information, as shown in FIG. 4D. The QoE measurement reporting is reported to the MN through SRB4, and the QoE measurement reporting is also reported to the SN through SRB3, split SRB4 or new SRB5. The DL information includes at least one of the following: DLInformationTransfer, RRC message, MAC CE contains the indication information, and the DCI contains the indication information. The RRC message contains at least one of the following: RRCReestablishment, RRCReconfiguration, RRCResume, RRCReject, RRCSetup.

FIG. 4E shows a schematic diagram of QoE measurement reporting according to an embodiment.

The MN or the SN configures QoE measurement information, and the MN or the SN can indicate the UE to report measurement reporting to the MN or the SN by an indication information, as shown in FIG. 4E. The QoE measurement reporting is reported to the MN through SRB4, and the QoE measurement reporting is also reported to the SN through SRB3, split SRB4 or new SRB5.

### Embodiment 5 (Alignment of QoE Measurements (Including Legacy QoE and RAN Visible QoE Measurements) and MDT in NR-DC)

FIG. 5 shows a schematic diagram of alignment of QoE measurements according to an embodiment.

When both legacy QoE/RAN visible QoE measurement and MDT measurement are activated, it is necessary to correlate the above two measurement results in order to facilitate the joint analysis of QoE measurement results and MDT measurement results by the core network or gNB. In other words, the two measurement results are correlated with assistant information in the measurement reports of legacy QoE and RAN visible QoE. The assistant information contains at least one of the following information: absolute timestamp, relative timestamp, slice information, QoE measurement ID, RAN visible QoE measurement ID.

Further, based on the reporting method of the measurement results and the main body of the analysis of the measurement results, the scenario containing the above assistant information includes at least one of the following:
UE contains the above assistant information in reporting the QoE measurement report to SN.
UE contains the above assistant information in reporting the QoE measurement report to MN.
SN sends a QoE measurement report containing the above assistant information to MN.
MN sends a QoE measurement report containing the above assistant information to SN.

### Embodiment 6 (Legacy QoE Measurements During Intra-5GC Inter-RAT Handover Process)

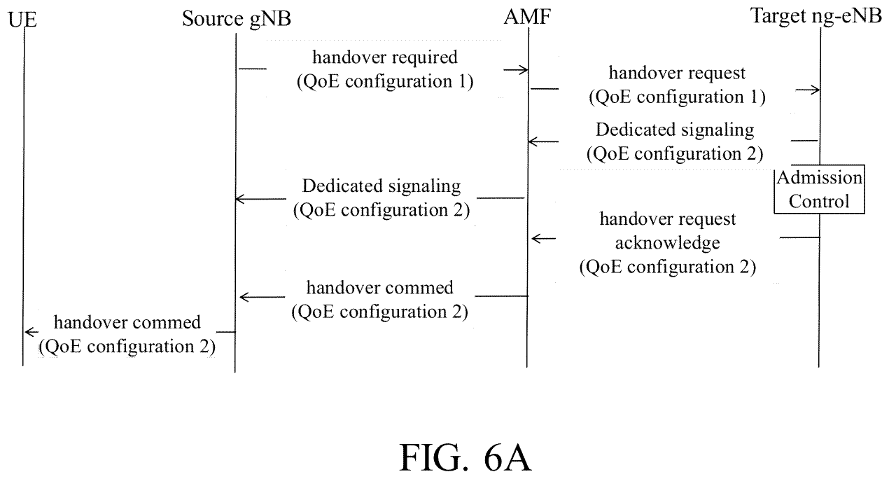

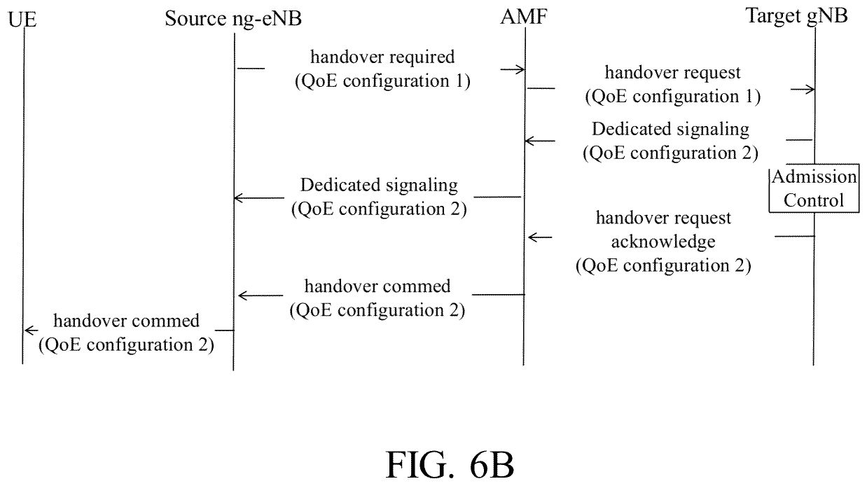

FIG. 6A shows a schematic diagram of legacy QoE measurements according to an embodiment.

During handover from gNB to ng-eNB, the source gNB needs to down select one of QoE measurement collection jobs of a service type with QoE measurement continuity.

QoE configuration 1 includes at least one of the following: service Type; measConfigAppLayerContainer-r17; QoE metric; Reporting Server information; Reporting interval; QoE Measurement Collection identifier for the session; QoE Area Scope information.

QoE configuration 2 includes at least one of the following: measConfigAppLayer-r15; An indication of whether to support the QoE measurement of the current service; An indication of a measConfigAppLayerId that continuously performs QoE measurements; An indication instructing the UE to report according to the format of the ng-eNB after the handover is completed.

FIG. 6B shows a schematic diagram of legacy QoE measurements according to an embodiment.

During handover from ng-eNB to gNB, the target gNB allocates the measConfigAppLayerId of the on-going QoEmeasurement.

QoE configuration 1 includes at least one of the following: service Type; measConfigAppLayer-r15; QoE metric; Reporting Server information; Reporting interval; QoE Area Scope information. QoE configuration 2 includes at least one of the following: AppLayerMeasConfig; An indication of whether to support the QoE measurement of the current service (with An indication of a measConfigAppLayerId); An indication instructing the UE to report according to the format of the gNB after the handover is completed; QoE Measurement Collection identifier for the session.

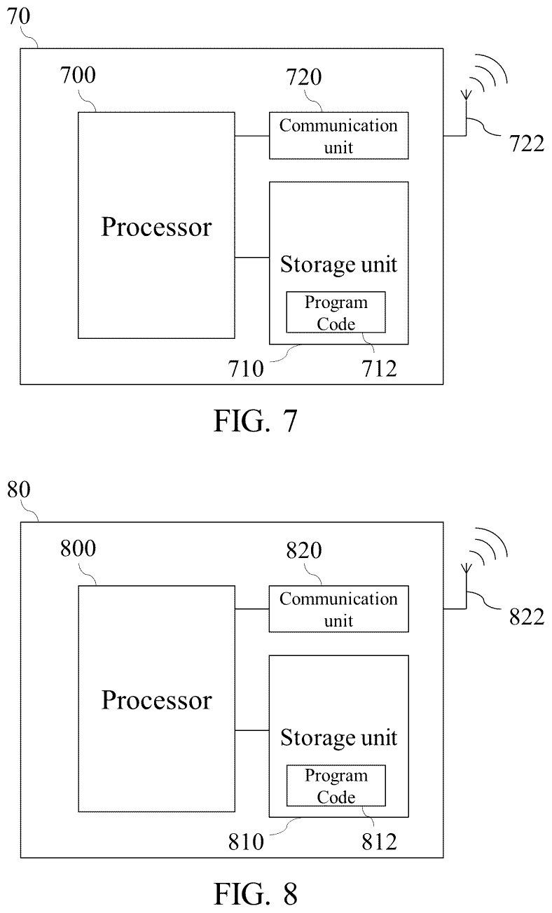

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 712 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g. messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g. a base station).

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 812 include but are not limited to a SIM, ROM, flash memory, RAM, hard-disk, and optical data storage device. The communication unit 820 may be a transceiver and is used to transmit and receive signals (e.g. messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g. a user equipment or another wireless network node).

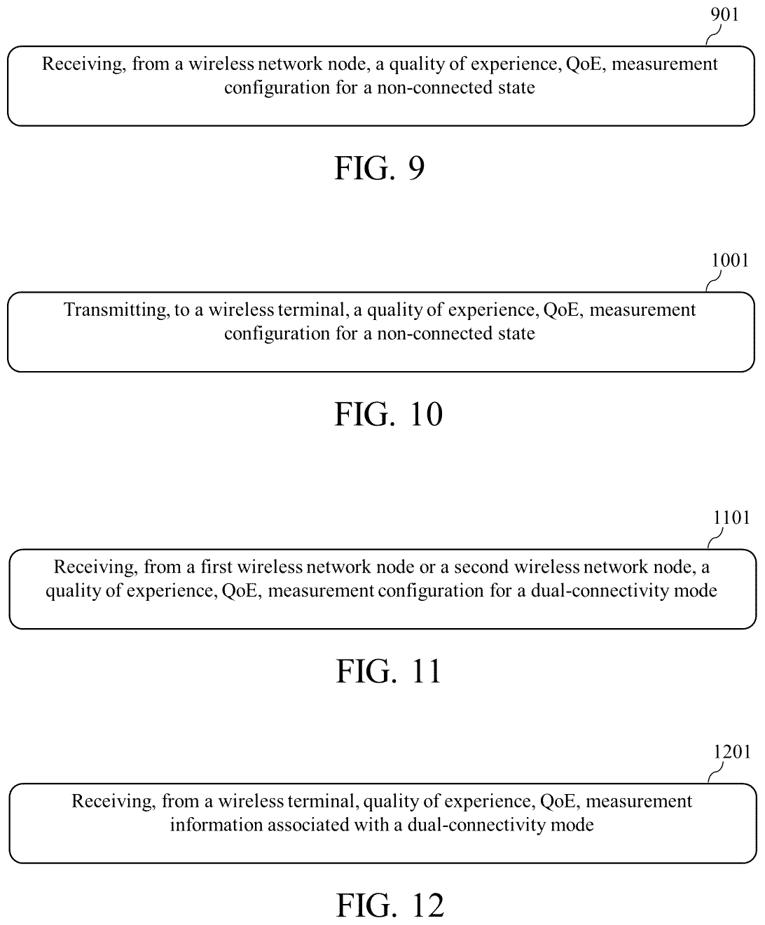

FIG. 9 shows a flowchart of a method according to an embodiment of the present disclosure. In particular, FIG. 9 relates to a wireless communication method for use in a wireless terminal, the method comprising:
receiving 901, from a wireless network node, a quality of experience, QoE, measurement configuration for a non-connected state.
wherein the non-connected state comprises an idle state and/or an inactive state.

In an embodiment, the method, in particular the QoE measurement configuration for the non-connected state, more particularly receiving the QoE measurement configuration for the non-connected state, comprises:
receiving, from the wireless network node, an indication of the QoE measurement configuration for a connected state being applicable for the QoE measurement configuration for the non-connected state,
wherein the indication is in a radio resource control, RRC, reconfiguration message or an RRC resume message.

In an embodiment, the QoE measurement configuration in the non-connected state comprises:
receiving, from the wireless network node, the QoE measurement configuration for the non-connected state when releasing QoE measurement configuration for a connected state,
wherein the QoE measurement configuration for the at least one non-connected state is in an RRC release message.

In an embodiment, the QoE measurement configuration in the non-connected state comprises:
receiving, from the wireless network node, modification information when releasing QoE measurement configuration for a connected state,
wherein the QoE configuration for the non-connected state is determined based on the QoE measurement configuration for the connected state and the modification information in an RRC release message.

In an embodiment, the QoE measurement configuration for the non-connected state is an application layer measurement configuration, AppLayerMeasConfig, and the QoE measurement configuration comprises at least one of:
a measurement configuration App Layer To Add Modify List,
a measurement Configuration App Layer To Release List,
an RRC segmentation Allowed,
a measurement Configuration App Layer identifier,
a measurement Configuration App Layer Container,
a service Type,
a pause Reporting,
a transmission Of Session Start Stop,
a network slice list,
short internet protocol information,
a periodicity,
a number of Buffer Level Entries, or
a Report Playout Delay For Media Start up.

In an embodiment, the wireless terminal is in the non-connected state, and the method further comprises:
transmitting, to the wireless network node, QoE measurement information based on a periodicity or at least one triggering event.

In an embodiment, the QoE measurement information relates to a QoE report.

In an embodiment, the wireless terminal is in the non-connected state, and the method further comprises:
switching to a connected state based on at least one triggering event, and transmitting, to the wireless network node, QoE measurement information.

In an embodiment, the QoE measurement information is transmitted in a message 3 or a message 5 of a random access procedure for switching to the connected state.

In an embodiment, the switching to the connected state based on at least one triggering condition comprises:
transmitting, to the wireless network node, an indication of a QoE measurement reporting being triggered, and
receiving, from the wireless network node, a request for the QoE measurement information.

In an embodiment, the QoE, measurement configuration is associated with at least one of an augmented reality service, a mixed reality service or a multicast and broadcast service, and the QoE measurement information comprises at least one of:
a QoE measurement report,
a radio access network visible QoE, RVQOE, measurement report,
a QoE measurement reporting value,
a RVQoE measurement reporting value, or
an application layer indication indicating an effect of user experience.

In an embodiment, the at least one triggering event comprises at least one of:
an indication from an application layer,
a QoE measurement reporting value exceeds a threshold,
a RVQoE reporting value exceeds the threshold, or
one or more indicators in the QoE measurement report respectively exceed one or more thresholds corresponding to the one or more indicators.

In an embodiment, the method further comprises:
transmitting, to the wireless network node, capability information of supporting QoE measurements in the non-connected state, and
transmitting, to the wireless network node, capability information of supporting QoE measurements for at least one of augmented reality service, mixed reality service or multicast and broadcast service.

FIG. 10 shows a flowchart of a method according to an embodiment of the present disclosure. In particular, FIG. 10 relates to a wireless communication method for use in a wireless network node, the method comprising:
transmitting 1001, to a wireless terminal, a quality of experience, QoE, measurement configuration for a non-connected state,
wherein the non-connected state comprises an idle state and/or an inactive state.

In an embodiment, the method, particularly the QoE measurement configuration for the non-connected state, more particularly transmitting the quality of experience, QoE, measurement configuration for a non-connected state, comprises at least one of:
transmitting, to the wireless terminal, an indication of the QoE measurement configuration by a radio resource control, RRC, reconfiguration message or an RRC resume message, or
transmitting, to the wireless terminal, the QoE measurement configuration by RRC release message, or
transmitting, to the wireless terminal, modification information by RRC release message

In an embodiment, the wireless terminal is in the non-connected state, and the method further comprises at least one of:
receiving, from the wireless terminal, QoE measurement information based on a periodicity or at least one triggering event, or
receiving, from the wireless terminal, an indication of a QoE measurement reporting being triggered.

In an embodiment, QoE measurement information relates to a QoE report.

In an embodiment, the QoE measurement configuration is associated with at least one of an augmented reality service, a mixed reality service or a multicast and broadcast service, and the QoE measurement information comprises at least one of:
a QoE measurement report,
a radio access network visible QoE, RVQOE, measurement report,
a QoE measurement reporting value,
a RVQoE measurement reporting value, or
an application layer indication indicating an effect of user experience.

In an embodiment, the at least one triggering event comprises at least one of:
an indication from an application layer,
a QoE measurement reporting value exceeds a threshold,
a RVQoE reporting value exceeds the threshold, or
one or more indicators in the QoE measurement report respectively exceed one or more thresholds corresponding to the one or more indicators.

In an embodiment, the method further comprises:
receiving, from the wireless terminal, capability information of supporting QoE measurements in the non-connected state, and
receiving, from the wireless terminal, capability information of supporting QoE measurements for at least one of augmented reality service, mixed reality service or multicast and broadcast service.

FIG. 11 shows a flowchart of a method according to an embodiment of the present disclosure. In particular, FIG. 11 relates to a wireless communication method for use in a wireless terminal, the method comprising:
receiving 1101, from a first wireless network node or a second wireless network node, a quality of experience, QoE, measurement configuration for a dual-connectivity mode,
wherein the first wireless network node is one of a master node and a secondary node and the second wireless network node is another one of the master node and the secondary node.

In an embodiment, the method further comprises:
transmitting QoE measurement information associated with the dual-connectivity mode to the first wireless network node based on the QoE measurement configuration for the dual-connectivity mode.

In an embodiment, the method further comprises:
transmitting, to the second wireless network node, the QoE measurement information based on the QoE measurement configuration for the dual-connectivity mode.

In an embodiment, the method further comprises:
receiving, from the first wireless network node or the second wireless network node, an indication associated with reporting the QoE measurement information, and
transmitting, to the second wireless network node or the first wireless network node, the QoE measurement information,
wherein the indication is in downlink control information, a radio resource control message or a media access control control element.

In an embodiment, the QoE measurement information is transmitted to the master node via a signaling radio bearer 4, and the QoE measurement information is transmitted to the secondary node via at least one of a signaling radio bearer 3, a split signaling radio bearer 4 or a signaling radio bearer configured for reporting the QoE measurement information associated with the dual-connected mode.

In an embodiment, the method further comprises:
transmitting, to the first or secondary wireless network node, assistance information associated aligning measurement results in the QoE measurement information,
wherein the assistance information comprises at least one of:
an absolute timestamp,
a relative timestamp,
network slice information,
a QoE measurement identifier, or
a radio access network visible QoE measurement identifier.

In an embodiment, the QoE measurement configuration is associated with at least one of an augmented reality service, a mixed reality service or a multicast and broadcast service, and wherein the wireless communication method further comprises:
transmitting, to the first wireless network node or the second wireless network node, capability information of supporting QoE measurements for at least one of the augmented reality service, the mixed reality service or the multicast and broadcast service.

FIG. 12 shows a flowchart of a method according to an embodiment of the present disclosure. In particular, FIG. 12 relates to a wireless communication method for use in a first wireless network node, the method comprising:
receiving 1201, from a wireless terminal, quality of experience, QoE, measurement information associated with a dual-connectivity mode,
wherein the first wireless network node is one of a master node and a secondary node connected to the wireless terminal.

In an embodiment, the method further comprises:
receiving, from the wireless terminal, the QoE measurement information based on the QoE measurement configuration for the dual-connectivity mode.

In an embodiment, the method further comprises:
transmitting an indication associated with reporting the QoE measurement information, and
receiving, from the wireless terminal, the QoE measurement information,
wherein the indication is in downlink control information, a radio resource control message or a media access control control element.

In an embodiment, the QoE measurement information is received via a signaling radio bearer 4, and the QoE measurement information is received via at least one of a signaling radio bearer 3, a split signaling radio bearer 4 or a signaling radio bearer configured for reporting the QoE measurement information associated with the dual-connected mode.

In an embodiment, the method further comprises:
receiving, from the wireless terminal, assistance information associated aligning measurement results in the QoE measurement information,
wherein the assistance information comprises at least one of:
an absolute timestamp,
a relative timestamp,
network slice information,
a QoE measurement identifier, or
a radio access network visible QoE measurement identifier.

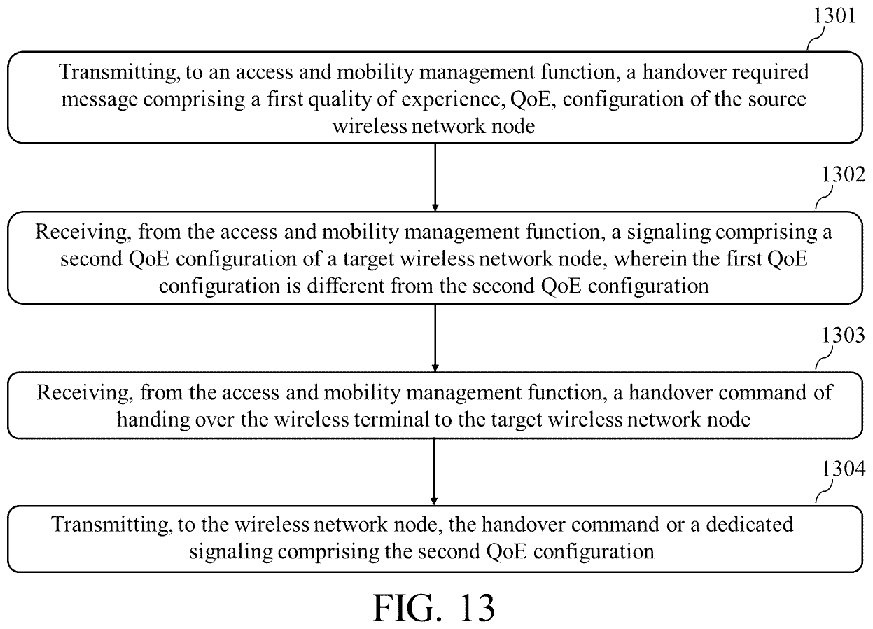

FIG. 13 shows a flowchart of a method according to an embodiment of the present disclosure. In particular, FIG. 13 relates to a wireless communication method for use in a source wireless network node, the method comprising:
transmitting 1301, to an access and mobility management function, a handover required message comprising a first quality of experience, QoE, configuration of the source wireless network node,
receiving 1302, from the access and mobility management function, a signaling comprising a second QoE configuration of a target wireless network node, wherein the first QoE configuration is different from the second QoE configuration,
receiving 1303, from the access and mobility management function, a handover command of handing over the wireless terminal to the target wireless network node, and
transmitting 1304, to the wireless network node, the handover command or a dedicated signaling comprising the second QoE configuration.

In an embodiment, the source wireless network node is one of a gNB or a next generation eNodeB, ng-eNB, and the target wireless network node is another one of the gNB and the ng-eNB.

In an embodiment, the first QoE configuration comprises at least one of:
a service type,
a measurement configuration for application layer of the source wireless network node,
a QoE metric,
reporting server information,
a reporting interval,
a QoE measurement collection identifier for a session, or
QoE area scope information.

In an embodiment, the second QoE configuration comprises at least one of:
a measurement configuration for application layer of the target wireless network node,
an indication of whether to support QoE measurements of an existing service,
an indication of a measurement configuration application layer identifier for
performing the QoE measurements of the existing service, or
an indication associated with instructing the wireless terminal to report according to a format of the target wireless network node after the handover is completed, or
a QoE measurement collection identifier for a session.

The present disclosure relates to a computer program product comprising a computer-readable program medium code stored thereupon, the code, when executed by a processor, causing the processor to implement a wireless communication method recited in any one of foregoing methods.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analogy implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

### APPENDIX

| | |
|---|---|
| RRC segmentation | This field, when received in |
| Allowed | MeasConfigAappLayerMeasConfigList, indicates |
| | that RRC segmentation of |
| | MeasurementReportAppLayer is allowed. It may |
| | be present only if the UE supports RRC message |
| | segmentation. |
| measurement | The MeasConfigAppLayerId identifies the |
| Configuration | application layer measurement. |
| App Layer Id | |
| measurement | The field contains configuration of application |
| Configuration | layer measurements, |
| App Layer | |
| Container | |
| service Type | Indicates the type of application layer |
| | measurement. |
| pause Reporting | The field indicates whether the transmission of |
| | measReportAppLayerContainer is paused or not. |
| transmission Of | The field indicates whether the UE shall transmit |
| Session Start Stop | indications when sessions in the application layer |
| | start and stop. The UE transmits a session start |
| | indication upon configuration of this field if a |
| | session already has started in the application layer. |
| slice list | a list of slice ID |
| Short IP information | The Short IP Info is a kind of mark which is used |
| | to let UE know the destination of the generated |
| | logged QoE reports in some cases. It may be a bit |
| | string or a number. |
| Number Of Buffer | The field contains the maximum number of buffer |
| Level Entries | level entries that can be reported for RAN visible |
| | application layer measurements. |
| Report Playout | The field indicates whether the UE shall report |
| Delay For Media | Initial Playout Delay for RAN visible application |
| Start up | layer measurements. |

### List of Abbreviations

AR Augmented Reality
MR Mixed Reality
MBS multicast and broadcast service
MTSI multimedia telephony service
QOE Quality of Experience
OAM Operations, Administration and Maintenance
QMC QoE measurement collection
CU Central Unit
DU Distributed Unit
F1AP F1AP Protocol
CN Core Network
MN Master Node
SN Secondary Node
UE User Equipment
RAN Radio Access Network
5G NR 5G New Radio
DC Dual Connectivity
RRC Radio Resource Control
RVQOE Radio Access Network visible QoE
ng-eNB next generation eNodeB

1. A wireless communication method for use in a wireless terminal, the wireless communication method comprising:
receiving, from a wireless network node, a quality of experience (QoE) measurement configuration for a non-connected state,
wherein the non-connected state comprises at least one of: an idle state or an inactive state.

2. The wireless communication method of claim 1, wherein receiving, from the wireless network node, the QoE measurement configuration for the non-connected state comprises:
receiving, from the wireless network node, an indication of the QoE measurement configuration for a connected state being applicable for the QoE measurement configuration for the non-connected state,
wherein the indication is in a radio resource control (RRC) reconfiguration message or an RRC resume message.

3. The wireless communication method of claim 1, wherein the QoE measurement configuration for the non-connected state is an application layer measurement configuration, AppLayerMeasConfig, and the QoE measurement configuration comprises at least one of:
a measurement Configuration App Layer identifier,
a service Type,
a number of Buffer Level Entries, or
a Report Playout Delay For Media Start up.

4. The wireless communication method of claim 1, wherein the wireless terminal is in the non-connected state, and
wherein the wireless communication method further comprises:
switching to a connected state based on at least one triggering event, and
transmitting, to the wireless network node, QoE measurement information.

5. The wireless communication method of claim 1, further comprising:
transmitting, to the wireless network node, capability information of supporting QoE measurements in the non-connected state.

6. A wireless communication method for use in a wireless network node, the wireless communication method comprising:
transmitting, to a wireless terminal, a quality of experience (QoE) measurement configuration for a non-connected state,
wherein the non-connected state comprises an idle state and/or an inactive state.

7. The wireless communication method of claim 6, wherein the wireless terminal is in the non-connected state, and
wherein the method further comprises receiving, from the wireless terminal, an indication of a QoE measurement reporting being triggered.

8. A wireless communication method for use in a wireless terminal, the method comprising:
receiving, from a first wireless network node or a second wireless network node, a quality of experience (QoE) measurement configuration for a dual-connectivity mode,
wherein the first wireless network node is one of a master node and a secondary node and the second wireless network node is another one of the master node and the secondary node.

9. The wireless communication method of claim 8, further comprising:
transmitting QoE measurement information associated with the dual-connectivity mode to the first wireless network node based on the QoE measurement configuration for the dual-connectivity mode.

10. The wireless communication method of claim 8, further comprising:
receiving, from the first wireless network node or the second wireless network node, an indication associated with reporting the QoE measurement information, and
transmitting, to the second wireless network node or the first wireless network node, the QoE measurement information,
wherein the indication is in a radio resource control message.

11. The wireless communication method of claim 8, wherein the QoE measurement information is transmitted to the master node via a signaling radio bearer 4, and the QoE measurement information is transmitted to the secondary node via a signaling radio bearer configured for reporting the QoE measurement information associated with the dual-connected mode.

12. A wireless terminal comprising a processor, wherein the processor is further configured to perform the method according to claim 1.

13. The wireless terminal of claim 12, wherein receiving, from the wireless network node, the QoE measurement configuration for the non-connected state comprises:
receiving, from the wireless network node, an indication of the QoE measurement configuration for a connected state being applicable for the QoE measurement configuration for the non-connected state,
wherein the indication is in a radio resource control (RRC) reconfiguration message or an RRC resume message.

14. The wireless terminal of claim 12, wherein the QoE measurement configuration for the non-connected state is an application layer measurement configuration, AppLayerMeasConfig, and the QoE measurement configuration comprises at least one of:
a measurement Configuration App Layer identifier,
a service Type,
a number of Buffer Level Entries, or
a Report Playout Delay For Media Start up.

15. The wireless terminal of claim 12, wherein the wireless terminal is in the non-connected state, and
wherein the processor is further configured to:
switch to a connected state based on at least one triggering event, and
transmit, to the wireless network node, QoE measurement information.

16. The wireless terminal of claim 12, wherein the processor is further configured to:
transmit, to the wireless network node, capability information of supporting QoE measurements in the non-connected state.

17. A wireless network node comprising a processor, wherein the processor is further configured to perform the method according to claim 6.

18. The wireless network node according to claim 17, wherein the wireless terminal is in the non-connected state, and
wherein the processor is further configured to perform receiving, from the wireless terminal, an indication of a QoE measurement reporting being triggered.

19. A wireless terminal comprising a processor, wherein the processor is further configured to perform the method according to claim 8.

20. The wireless terminal according to claim 19, wherein the processor is further configured to perform transmitting QoE measurement information associated with the dual-connectivity mode to the first wireless network node based on the QUE measurement configuration for the dual-connectivity mode.
